(19) United States
(12) Patent Application Publication
(10) Pub. No.: US 2020/0092376 A1
(43) Pub. Date: Mar. 19, 2020

(54) INTERNET-OF-THINGS (IOT) SERVER AND IOT SYSTEM INCLUDING THE SAME

(71) Applicant: SAMSUNG ELECTRONICS CO., LTD., SUWON-SI (KR)

(72) Inventor: Peter MORRIS, Yongin-si (KR)

(21) Appl. No.: 16/387,641

(22) Filed: Apr. 18, 2019

(30) Foreign Application Priority Data
Sep. 14, 2018 (KR) 10-2018-0110291

(51) Int. Cl. H04L 29/08; H04L 12/24

(52) U.S. Cl. CPC H04L 67/125; H04L 41/12

(57) ABSTRACT

An Internet-of-Things (IoT) server includes a storage configured to store function information of a plurality of IoT devices. The stored function information of the plurality of IoT devices are classified based on IoT functions to be implemented in an IoT environment. The IoT server further includes a controller configured to generate a second command to control a target device among the plurality of IoT devices to execute at least one IoT function of the IoT functions, in response to a first command from an IoT application. The first command is converted into a format executable in the target device and transmitted to the target device as the second command.

### CROSS-REFERENCE TO RELATED APPLICATIONS)

This application claims priority under 35 U.S.C. § 119 to Korean Patent Application No. 10-2018-0110291 filed on Sep. 14, 2018 in the Korean Intellectual Property Office, the disclosure of which is incorporated by reference herein in its entirety.

### TECHNICAL FIELD

Exemplary embodiments of the present inventive concept relate to an Internet-of-Things (IoT) server and an IoT system including the same.

### DISCUSSION OF THE RELATED ART

An Internet-of-Things (IoT) system is a technology for controlling IoT devices equipped with an IoT module for transmitting and receiving data through an IoT network, and providing various functions by sharing data collected by the IoT devices. In an IoT system, a plurality of IoT devices transmit and receive or share data with each other through an IoT network provided by an IoT server, and the plurality of IoT devices may communicate with each other using an IoT application that can connect to the IoT network.

IoT devices, produced and sold by various manufacturers and configured for different IoT systems, may be connected to an IoT network. Thus, when compatibility between IoT devices is not sufficiently secured, a user individually authenticates and/or connects the IoT devices to an IoT network. Moreover, due to a difference in contexts to be recognized by respective IoT devices, a control command exchange that occurs between IoT devices and an IoT application may not be performed normally.

### SUMMARY

According to an exemplary embodiment of the present inventive concept, an Internet-of-Things (IoT) server, including: a storage configured to store function information of a plurality of IoT devices, wherein the stored function information of the plurality of IoT devices are classified based on IoT functions to be implemented in an IoT environment; and a controller configured to generate a second command to control a target device among the plurality of IoT devices to execute at least one IoT function of the IoT functions, in response to a first command from an IoT application, wherein the first command is converted into a format executable in the target device and transmitted to the target device as the second command.

According to an exemplary embodiment of the present inventive concept, an Internet-of-Things (IoT) server, including: a network generation unit configured to provide an IoT network, wherein the IoT network includes a plurality of IoT devices that receive commands in different formats to implement IoT functions and a user terminal executing an IoT application for controlling the plurality of IoT devices; and a processor configured to store function information of the plurality of IoT devices and classify the function information according to the IoT functions, to generate a command in a formal to be executed by each of the plurality of IoT devices, and to transmit the command to the plurality of IoT devices in response to a control command from the IoT application.

According to an exemplary embodiment of the present inventive concept, an Internet-of-Things (IoT) server, including: a storage configured to store function information corresponding to IoT functions provided by a plurality of IoT devices in a space; and a controller configured to select a target function among the IoT functions and a target device among the plurality of IoT devices in response to a first command from an IoT application, to generate a second command for providing the target function in a format executable in the target device, and to transmit the second command to the target device.

### BRIEF DESCRIPTION OF DRAWINGS

The above and other features of the present inventive concept will become more apparent by describing in detail exemplary embodiments thereof, with reference to the accompanying drawings, in which:

FIGS. 1 and 2 are schematic drawings illustrating an Internet-of-Things (IoT) system according to an exemplary embodiment of the present inventive concept;

FIG. 3 is a drawing illustrating a process for Internet-of-Things (IoT) devices to be connected to an IoT server according to an exemplary embodiment of the present inventive concept;

FIG. 4 is a schematic block diagram illustrating an operation of an IoT server according to an exemplary embodiment of the present inventive concept;

FIG. 5 is a schematic block diagram illustrating an IoT server according to an exemplary embodiment of the present inventive concept;

FIG. 6 is a flow diagram Illustrating a method of an operation of an IoT server according to an exemplary embodiment of the present inventive concept;

FIG. 7 is a diagram illustrating an IoT environment in which an IoT service is provided by an IoT server according to an exemplary embodiment of the present inventive concept; and

FIGS. 8, 9, 10, 11, 12 and 13 are schematic diagrams illustrating an operation of an IoT server according to an exemplary embodiment of the present inventive concept.

### DETAILED DESCRIPTION OF THE EMBODIMENTS

Hereinafter, the exemplary embodiments of the present inventive concept will be described in detail with reference to the attached drawings.

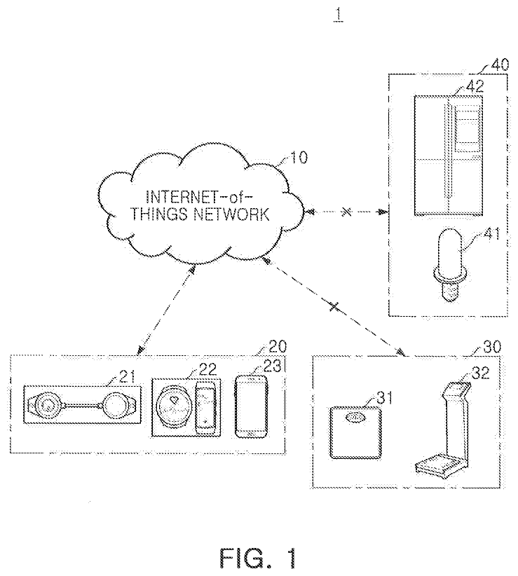

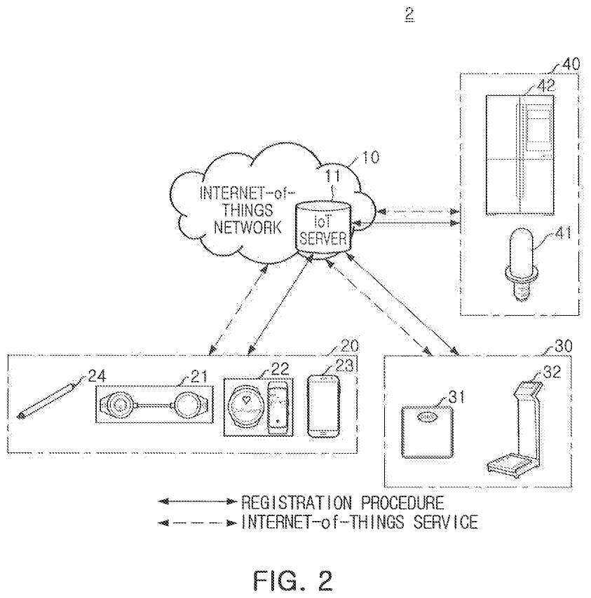

FIGS. 1 and 2 are schematic drawings illustrating an Internet-of-Things (IoT) system according to an exemplary embodiment of the present inventive concept.

Referring to FIG. 1, an IoT system 1 may include a plurality of IoT devices 21 to 24, 31 and 32, as well as 41 and 42, and an IoT network 10 for mediating communications among the plurality of IoT devices 21 to 24, 31 and 32, as well as 41 and 42. The IoT network 10 may be provided by an IoT server, and the IoT server may mediate communications among the plurality of IoT devices 21 to 24, 31 and 32, as well as 41 and 42 via the IoT network 10 and may provide cloud services, or the like.

An IoT module with data storage and processing functions, in addition to a communications function with the IoT network 10, may be mounted on or included in the plurality of IoT devices 21 to 24, 31 and 32, as well as 41 and 42. The IoT module may include a processor configured to perform arithmetic processing and data processing functions, a memory for storing data, a sensor for collecting surrounding information, a communications unit (e.g., a transceiver and receiver), and the like. For example, the IoT module, included in a wearable device 22, may include a sensor detecting a body temperature, a heart rate, a pulse rate, skin humidity, movement, location and the like, of a user, equipped with the wearable device 22. A refrigerator 42 may include a sensor measuring internal temperature, humidity, and the like.

In an exemplary embodiment of the present inventive concept, a module manufacturer, producing and selling an IoT module, may be the same as or different from device manufacturers 20 to 40, producing and selling a plurality of IoT devices 21 to 24, 31 and 32, as well as 41 and 42. In other words, the device manufacturers 20 to 40 may purchase an IoT module from a module manufacturer, and may then produce and/or sell various IoT devices 21 to 24, 31 and 32, as well as 41 and 42 using the purchased IoT module. For example, in the IoT system 1, illustrated in FIG. 1, a first device manufacturer 20 may be a company producing a device such as a biometric information measuring device 21, a wearable device 22, a smartphone 23, a lighting device 24, and the like, while a second device manufacturer 30 may be a company producing a scale 31, a body information measuring device 32, and the like. In addition, a third device manufacturer 40 may be a company producing a product such as a lighting device 41, a refrigerator 42, or the like.

As described above, the device manufacturers 20 to 40, producing and selling the IoT devices 21 to 24, 31 and 32, as well as 41 and 42, with an IoT module mounted on or included in, are varied, and the type of the IoT devices 21 to 24, 31 and 32, as well as 41 and 42, produced and sold thereby, is also varied. In this regard, securing scalability and compatibility of the IoT system 1 may not be effectively achieved. For example, if the first device manufacturer 20 is a module manufacturer producing an IoT module, while providing and maintaining/managing the IoT network 10, IoT devices 31 and 32, produced and sold by the second device manufacturer 30, as well as IoT devices 41 and 42, produced and sold by the third device manufacturer 40, may not be registered in the IoT system 1 even though the IoT module is mounted on or included therein.

In addition, by a development process of the IoT devices 21 to 24, 31 and 32, as w;ell as 41 and 42, produced and sold by the device manufacturers 20 to 40, at least a portion of the IoT devices 21 to 24, 31 and 32, as well as 41 and 42 may implement the same function by commands in different formats. For example, the biometric information measuring device 21, produced by the first device manufacturer 20, and the biometric information measuring device 32, produced by the second device manufacturer 30, may each provide a function of measuring biometric information. However, due to difference in development processes, a command for measuring biometric information in the biometric information measuring device 21 of the first device manufacturer 20, and a command for measuring biometric information in the biometric information measuring device 32 of the second device manufacturer 30 may be different from each other. As a result, if a command for measuring biometric information is generated by a user terminal such as a wearable device 22, a smartphone 23, or the like, produced and sold by the first device manufacturer 20, the biometric information measuring device 32 of the second device manufacturer 30 may not perform an operation for measuring biometric information in response to the corresponding command.

Thus, to expand scalability of the IoT system 1, a user may search for an IoT device compatible with the IoT system 1, which the user uses, each time the user purchases an IoT device. Alternatively, the user may perform a direct authentication procedure for the IoT device they end up purchasing. Furthermore, a user may be limited to only those IoT devices that are produced by the same manufacturer as their user terminal. As a result, scalability of the IoT system 1 is limited.

In an exemplary embodiment of the present inventive concept, an IoT server, providing the IoT network 10, may provide compatibility among IoT devices, and thus, scalability of the IoT system 1 may be increased. The. IoT server may automatically recognize a new IoT device when the new IoT device is connected, based on an IoT function which may be provided by the IoT devices 21 to 24, 31 and 32, as well as 41 and 42. Moreover, the IoT server may convert a command for executing an IoT function into a format to be executed by each of the connected IoT devices 21 to 24, 31 and 32, as well as 41 and 42, and may transmit the command to the devices 21 to 24, 31 and 32, as well as 41 and 42. Thus, the IoT devices 21 to 24, 31 and 32, as well as 41, and 42, developed in different environments and/or produced by different device manufacturers 20, 30 and 40, may be compatible, so that scalability of the IoT system 1 may be increased.

Referring to FIG. 2, an IoT system 2 according to an exemplary embodiment of the present inventive concept may include an IoT network 10 as well as a plurality of IoT devices 21 to 24, 31 and 32, as well as 41 and 42, and the IoT network 10 may be provided by the IoT server 11. The IoT server 11 may provide the IoT network 10 used to operate the IoT system 2, and the IoT server 11 may perform authentication/registration procedures for the plurality of IoT devices 21 to 24, 31 and 32, as well as 41 and 42. Moreover, the server 11 may transmit a predetermined command to the plurality of IoT devices 21 to 24, 31 and 32, as well as 41 and 42, and the plurality of IoT devices 21 to 24, 31 and 32, as well as 41 and 42 may implement predetermined IoT functions in an IoT environment in which the IoT network 10 is built. For example, the IoT server 11 may transfer a command for implementing an IoT function to the plurality of IoT devices 21 to 24, 31 and 32, as well as 41 and 42, in response to a control command from a user terminal connected to the IoT network 10 or an IoT application executable in the IoT server 11 itself.

For example, the IoT device manufacturers 20 to 40 purchase an IoT module, and may then produce and sell the plurality of IoT devices 21 to 24, 31 and 32, as well as 41 and 42 with the IoT module mounted on or included therein. Before the device manufacturers 20 to 40 sell the plurality of IoT devices 21 to 24, 31 and 32, as well as 41 and 42 to an end-user, a registration procedure for storing pieces of information of the plurality of IoT devices 21 to 24, 31 and 32, as well as 41 and 42 in the IoT server 11 may be performed. In other words, the device manufacturers 20 to 40 may classify and store pieces of information of the IoT devices 21 to 24, 31 and 32, as well as 41 and 42 according to IoT functions stored in the IoT server 11 in advance of their purchase.

The IoT server 11 may receive and store predetermined IoT functions, in a releasing operation. The IoT functions may include general functions and/or services to be implemented in an IoT environment in which the IoT system 2 is implemented by the IoT server 11. In an exemplary embodiment of the present inventive concept, when an IoT environment in which the IoT system 2 is implemented is a home environment, the IoT server 11 may store, for example, illumination detection, illumination control, temperature detection, temperature control, humidity detection, humidity control, and the like, as IoT functions.

Before the IoT devices 21 to 24, 31 and 32, as well as 41 and 42 are released, the device manufacturers 20 to 40 may classify pieces of function information of the IoT devices 21 to 24, 31 and 32, as well as 41 and 42 according to IoT functions stored in the IoT server 11, and may register the function information in the IoT server 11. The pieces of function information of the IoT devices 21 to 24, 31 and 32, as well as 41 and 42 may be a function provided to an IoT environment in each of the IoT devices 21 to 24, 31 and 32, as well as 41 and 42. For example, a lighting device 24, produced by the first device manufacturer 20, and a lighting device 41, produced by a third device manufacturer 40, may provide a function to increase and decrease illumination to the IoT environment.

In an exemplary embodiment of the present inventive concept, an illumination increase function of the lighting device 24 and an illumination increase function of the lighting device 41 may be classified into the same IoT function, and the classification of the functions may be stored in the IoT server 11. In a similar manner, an illumination decrease function of the lighting device 24 and an illumination decrease function of the lighting device 41 are classified into the same IoT function, and the classification of the functions may be stored in the IoT server 11. The IoT server 11 may transmit a command for increasing or decreasing illumination to each of the lighting devices 24 and 41, in response to a control command from an IoT application, or according to a preset control process. The IoT server 11 may transmit commands in different formats to the lighting devices 24 and 41, respectively, according to characteristics of the lighting devices 24 and 41, for example, increasing or decreasing illumination by different instructions. Thus, when a user purchases and only connects the lighting devices 24 and 41 to the IoT network 10 without a separate operation, the lighting devices 24 and 41 may be operated in response to a command from the IoT server 11.

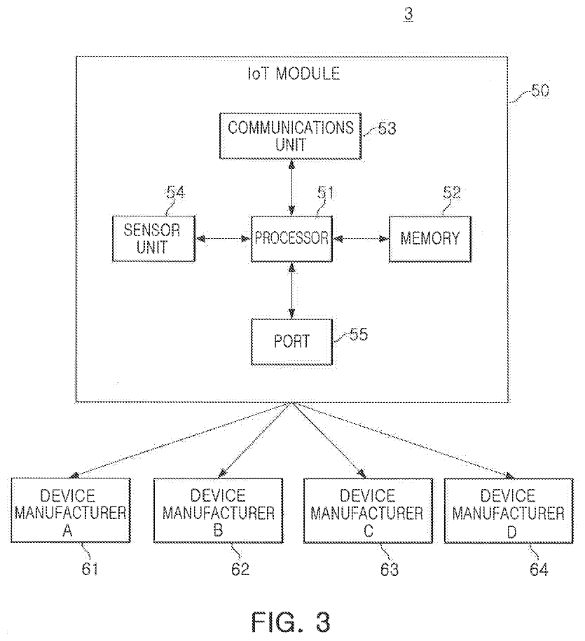

FIG. 3 is a drawing illustrating a process for IoT devices to be connected to an IoT server according to an exemplary embodiment of the present inventive concept.

Referring to FIG. 3, a module manufacturer may sell an IoT module 50 to a plurality of device manufacturers 61 to 64, different from each other. For example, the device manufacturers 61 to 64 may each produce devices that correspond to different IoT environments. The IoT modules, sold by the module manufacturer to respective device manufacturers 61 to 64, may be the same or different from each other, and the IoT module may be processed while the device manufacturers 61 to 64 produce the IoT devices. However, the IoT modules may be processed before or after the device manufacturers 61 to 64 produce the IoT devices.

An IoT module 50 according to an exemplary embodiment of the present inventive concept may include a processor 51, a memory 52, a communications unit 53, a sensor unit 54, a port 55, and the like. The processor 51 may be an arithmetic processing unit processing the overall operation of the IoT module 50.

The memory 52 may store data for an operation of the IoT module 50, data collected by the sensor unit 54, identification information of the IoT module 50, and the like, and may include elements such as a non-volatile memory, a dynamic memory, and the like. In an exemplary embodiment of the present inventive concept, the identification information may include identification information of a certificate stored in the memory 52, a serial number assigned to the IoT module 50, identification information given to the module manufacturer by an IoT network operator, and the like. The port 55 may be an interface device for mediating communications between an external device and the IoT module 50, and may provide communications with an external device according to various communications interfaces such as universal asynchronous receiver-transmitter (UART), universal serial bus (USB), inter-integrated circuit (I2C), and the like.

The communications unit 53 may provide a communications function for the IoT module 50 to operate while communicating with the IoT network after the IoT module 50 is mounted on and/or connected to a device. The communications unit 53 may send and receive data according to various wired/wireless communications interfaces. The sensor unit 54 may include various types of sensors such as an acceleration sensor, a global positioning system (GPS) sensor, a humidity sensor, a temperature sensor, a gas sensor, a heart rate sensor, a gyroscope sensor and the like. The number and type of sensors, included in the sensor unit 54, may be varied according to the type of a device with the IoT module 50 mounted therein.

To allow a consumer to purchase and use an IoT device without worrying about compatibility with IoT system, according to an exemplary embodiment, after pieces of information of IoT devices are registered in an IoT server, the IoT devices may be sold to consumers. For example, information of the IoT devices may be registered in the IoT server based on functions to be implemented by the IoT device and the IoT module 50 mounted therein. For example, temperature increase and temperature decrease functions, provided by an air conditioner which a device manufacturer A 61 produces/sells, and temperature increase and temperature decrease functions, provided by a boiler which a device manufacturer B 62 produces/sells, are classified into the same IoT function, and the classified functions may be registered in the IoT server.

When the IoT server receives a temperature increase command with respect to an IoT environment in which an air conditioner and a boiler are installed, a temperature of the IoT environment may be increased by stopping an operation of the air conditioner or operating the boiler. In this case, for example, commands transferred to the air conditioner and the boiler, respectively, to increase a temperature, include an instruction to be decoded and executed in the air conditioner and/or the boiler, and thus, the commands may have different formats. In an exemplary embodiment of the present inventive concept, a target device for implementing a specific IoT function is selected from IoT devices by an IoT server, and the IoT server may generate a command in a format executable by the target device and transmit the command to the target device.

For example, when a user inputs a control command using an IoT application, and the like, the IoT server selects a target device for implementing an IoT function corresponding to the inputted control command. The IoT server generates a command in a format executable by the target device and transmits the command to the target device. Thus, without any operation or intervention of a user, an IoT function, which the user desires, may be implemented by the IoT server.

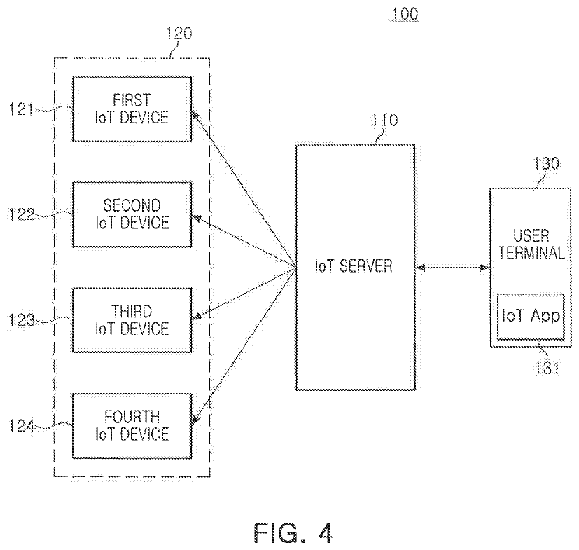

FIG. 4 is a schematic block diagram illustrating an operation of an IoT server according to an exemplary embodiment of the present inventive concept.

Referring to FIG. 4, an IoT server 110 according to an exemplary embodiment of the present inventive concept may provide an IoT system 100. The IoT system 100 may be implemented by a plurality of IoT devices 120 (e.g., IoT devices 121 to 124) and a user terminal 130, in addition to the IoT server 110. The number of the IoT devices 120 may be variously modified, and a plurality of user terminals 130 may be also provided according to an exemplary embodiment of the present inventive concept.

The user terminal 130 may be an electronic device capable of executing the IoT application 131, connected to the IoT server 100 and controlling an IoT function provided by the IoT system 100. For example, the user terminal 130 may include a smartphone, a tablet PC, a desktop computer, a laptop computer, a wearable device, and the like.

The IoT server 110 may provide a service and/or a network for providing the IoT system 100, while mediating communications between the IoT devices 120 and the user terminal 130. In an exemplary embodiment of the present inventive concept, the IoT server 110 may select a target device, front the IoT devices 120, for executing an IoT function according to a control command received front the IoT application 131. Moreover, the IoT server 110 may generate a command for executing an IoT function according to a corresponding control command, and may generate the command as a command in a format executable by the target device.

For example, the IoT server 110 may provide an IoT environment in which IoT functions can be implemented by the IoT devices 120, which have been developed by different processes and are thus being operated by different instructions. The IoT server 110 may store IoT functions, provided by respective IoT devices 120, and information on instructions for a command in formats executable by respective IoT devices 120, in advance. When a target device is determined, the IoT server 110 may generate a command including an instruction in a format suitable for the target device, so an IoT function, which a user desires, may be easily implemented in the target device despite heterogeneity of the IoT devices 120.

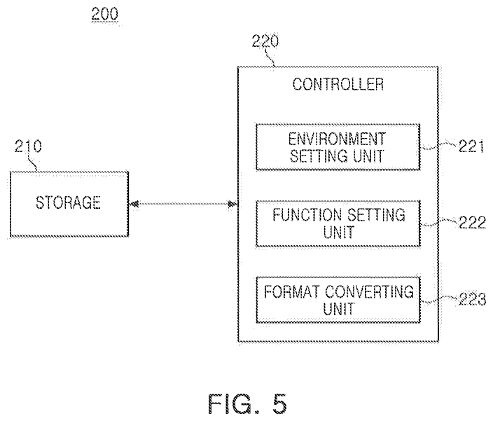

FIG. 5 is a schematic block diagram illustrating an IoT server according to an exemplary embodiment of the present inventive concept.

Referring to FIG. 5, an IoT server 200 according to an exemplary embodiment of the present inventive concept may include a storage 210 and a controller 220. The storage 210 is a component, capable of storing data, and may be implemented by various storage devices such as a hard disk drive, a flash memory, and the like.

The controller 220 is a component for controlling an overall operation of the IoT server 200, and may provide an IoT network through a communications module such as a network generation unit, and the like, while managing data stored in the storage 210, or performing various arithmetic functions. The controller 220 may be implemented in various forms such as a System on Chip (SoC), a microcontroller unit, a field programmable gate array (FPGA), and the like. In an exemplary embodiment of the present inventive concept, the controller 220 may classify function information of IoT devices in the storage 210. In an exemplary embodiment of the present inventive concept, the controller 220 may then select a target device from a plurality of IoT devices, connected to the IoT server 200, in response to a control command. The controller 220 may convert the control command into a format suitable for the target device and transmit the converted command to the target device.

To execute the function described above, the controller 220 may include components, such as an environment setting unit 221, a function setting unit 222, a format converting unit 223, and the like. The environment setting unit 221, the function setting unit 222, the format converting unit 223, and the like may be provided as a software module executable in the controller 220.

The environment setting unit 221 may provide an IoT environment to which an IoT service may be provided by IoT devices connected to the IoT server 200. For example, the environment setting unit 221 may directly receive an Io T environment from a user. The user may specify a space, in which an IoT environment is to be implemented, as provide the IoT environment. For example, the IoT environment may be a space in which an IoT network is formed by the IoT server 200.

The function setting unit 222 may set IoT functions provided by IoT devices connected to the IoT server 200. For example, if the IoT server 200 is connected to IoT devices such as an air conditioner, a boiler, a lighting device, an illumination sensor, a temperature sensor, a humidifier, a security device, and the like, IoT functions of the IoT environment may include illumination control, illumination detection, temperature control, temperature detection, humidity control, humidity detection, external intrusion detection, warning alarm, and the like. In other words, the IoT functions may be determined according to the type and number of IoT devices, and the like. For example, the IoT functions may be determined by a server provider, and may be provided to the IoT sewer 200, in advance. In addition, the IoT functions may be registered in the IoT server 200 by device manufacturers, producing/selling the IoT devices.

The format converting unit 223 may generate and/or covert a command, transmitted to IoT devices connected to the IoT server 200, into a command in a format executable in a corresponding IoT device. For example, when the plurality of lighting devices, produced and sold by different manufacturers, are connected to the IoT server 200, respective instructions for controlling illumination of the plurality of lighting devices may have different formats. The format converting unit 223 may generate a command having an instruction in a format suitable for a target device selected from a plurality of lighting devices. For example, the format converting unit 223 may generate a command to have an instruction in a format executable in a target device, with reference to information of IoT devices, stored in the storage 210. For example, the format converting unit 223 may generate a command based on the command sent to the IoT devices in a format that is executable by the target device.

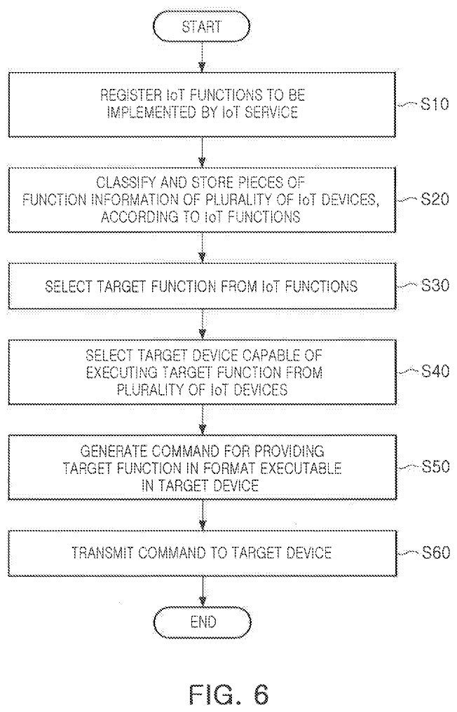

FIG. 6 is a flow diagram illustrating a method of an operation of an IoT sewer according to an exemplary embodiment of the present inventive concept.

Referring to FIG. 6, a method of an operation of an IoT server according to an exemplary embodiment of the present inventive concept may be started by registering IoT functions to be implemented by an IoT service provided by an IoT server (S10). For example, a registration procedure of S10 may be executed by a sewer provider providing an IoT sewer. The IoT functions may be provided a server provider, or the IoT functions may be added by a request of device manufacturers producing/selling IoT devices.

The IoT device manufacturers may input function information of the IoT devices into the IoT server. The IoT server may classify and store pieces of function information of IoT devices according to the IoT functions registered in S10 (S20). In S20, the IoT server may store the pieces of the function information of the IoT devices, according to the IoT functions, rather than based on a device. For example, when IoT devices, made by different manufacturers from each other, provide the same function, the IoT server may classify and store the pieces of function information of the IoT devices, different from each other, into a single IoT function on the IoT server.

When a control command is received from the IoT application, the IoT server may select a target function from IoT functions (S30). The IoT application may be a program executed in the IoT server itself, or executed in IoT devices, or a user terminal connectable to an IoT server. The IoT application may generate a control command according to an operation of a user and transmit the control command to the IoT server, or may generate a control command according to a preset condition and transmit the control command to an IoT server. For example, a user may directly execute an IoT application in a user terminal to increase or decrease illumination, thereby generating a control command. Moreover, a control command to increase or decrease illumination depending on conditions such as preset time, external illumination, a temperature, humidity, and the like, may be generated in an IoT application such as an IoT server, an IoT device, or the like.

The IoT server may select a target device, executing the target function selected in S30, from IoT devices (S40). For example, when the target function is increasing or decreasing illumination, the IoT server may select a lighting device as a target device, from the IoT devices. For example, when the target function is controlling a temperature, the IoT server may select an air conditioner, a boiler, or the like, as a target device, from the IoT devices. For example, when the target function is controlling a degree of air cleanliness, the IoT server may select an air purifier or an air conditioner as a target device. Since the pieces of the function information of the IoT devices are classified and stored according to the IoT functions in S20, the IoT server may select IoT devices, having function information corresponding to the IoT function selected as the target function, as a target device.

When the target device is selected, the IoT server may generate a command having an instruction for providing a target function, in a format to be executed by the target device (S50). The IoT devices may be produced and/or sold by various device manufacturers, so IoT devices, providing the same IoT function, may be operated by instructions in different formats. In an exemplary embodiment of the present inventive concept, the IoT server may generate a command having an instruction in a format to be executed by the target device with reference to the function information of the target device, and may transmit the command to the target device (S60). Thus, compatibility between various IoT devices, different from each other, may be provided. As a result, scalability of the IoT server and the IoT system may be increased.

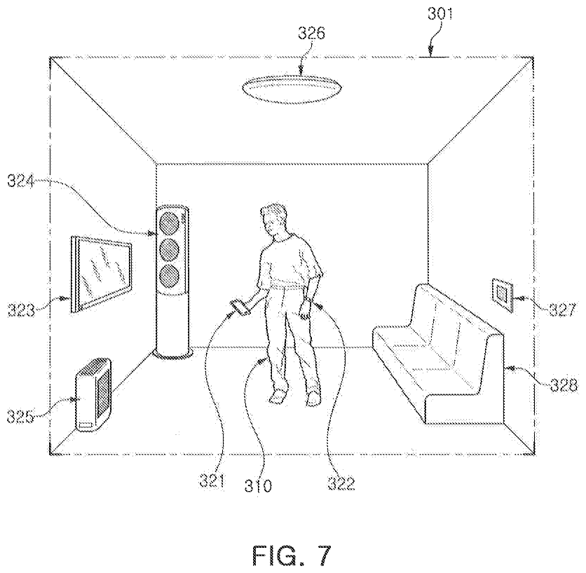

FIG. 7 is a diagram illustrating an IoT environment in which an IoT service is provided by an IoT server according to an exemplary embodiment of the present inventive concept.

In the embodiment illustrated in FIG. 7, an IoT environment 300 to which an IoT service is provided may be assumed to be a living room 301 in a house. However, according to an exemplary embodiment of the present inventive concept, the IoT server may also provide the IoT service to various IoT environments such as other spaces, offices, factories, roads, in addition to a living room environment in a house.

Referring to FIG. 7, a smartphone 321, a wearable device 322, a television 323, an air conditioner 324, a humidifier 325, a lighting device 326, an illumination sensor 327, a motion bed 328, and the like, provided in the living room 301, may be connected to the IoT service. The user 310 may use the IoT service using a user terminal such as the smartphone 321, the wearable device 322, and the like. The IoT application for using or controlling the IoT service may be execrated by the smartphone 321, the wearable device 322, and the like.

For example, the user 310 may operate the motion bed 328 using an IoT application installed in the smartphone 321 and/or the wearable device 322, while, for example, lying on the motion bed 328. Moreover, the user 310 may increase or decrease illumination by operating the lighting device 326 using the IoT application, or may control a temperature and/or humidity of indoor air using the air conditioner 324 and the humidifier 325.

When the user 310 inputs a control command for the IoT devices using the IoT application, the IoT server receives the control command and selects a target device from the IoT devices. For example, when the control command is a command to change illumination, the IoT server may select, for example, the lighting device 326 and/or the illumination sensor 327 as a target device. When the control command is a command to control humidity of indoor air, the IoT server may select the air conditioner 324 and/or the humidifier 325 as a target device.

The IoT server generates a command having an instruction in a format to be executed by the target device, based on the control command, and may transmit the command to the target device. The target device decodes the command, received from the IoT server, thereby implementing the IoT function, intended by the user 310. For example, when the user 310 desires to set indoor illumination to 100 lux (lx) using the IoT application, the IoT server may transmit a command for increasing or decreasing light output with reference to indoor illumination, detected by the illumination sensor 327, to the lighting device 326. The lighting device 326 may increase or decrease light output in response to the command, and may set indoor illumination to a value which the user 310 desires.

In an exemplary embodiment of the present inventive concept, the user 310 may set desired operating conditions in advance using the IoT application. The operating conditions, which the user 310 sets, may be transmitted to the IoT server through the IoT application, and the IoT server may control an operation of the IoT devices according to whether the operating conditions are satisfied.

For example, the user 310 may preset a predetermined reference range for indoor temperature and humidity. For example, when the user 310 sets an indoor temperature to 23 degrees to 25 degrees and humidity to 50% to 60% using the IoT application, the IoT server may receive a control command including the reference range from the IoT application. The control command may include an instruction for controlling indoor temperature and humidity to be within the reference range by operating the air conditioner 324, the humidifier 325, and the like, if the indoor temperature and humidity are outside of the reference range.

For example, the air conditioner 324 and the humidifier 325 may be produced by different device manufacturers, so instructions for operating the air conditioner 324 and the humidifier 325 may be provided in different formats. The IoT server may generate commands, including an instruction in a format for controlling the air conditioner 324 and an instruction in a format for controlling the humidifier 325, respectively, and transmit the commands to the conditioner 324 and the humidifier 325, respectively, to set the indoor temperature and humidity to the reference range.

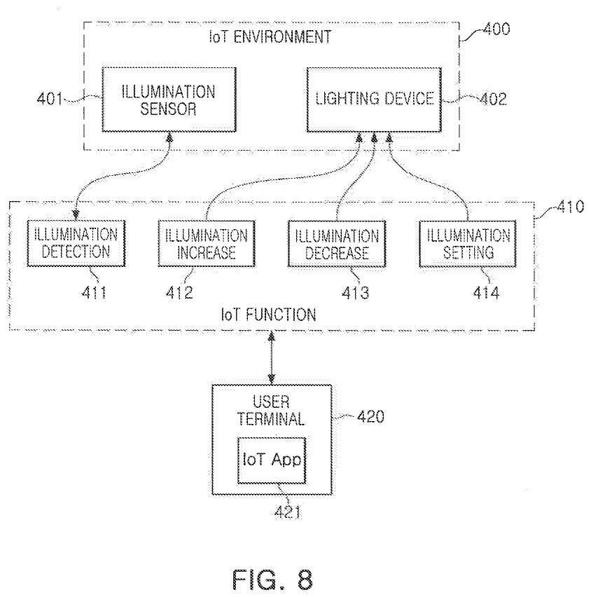

FIGS. 8, 9, 10, 11, 12 and 13 are schematic diagrams illustrating an operation of an IoT server according to an exemplary embodiment of the present inventive concept.

FIGS. 8 to 10 are drawings illustrating an operation of an IoT server, such as an illumination control function, by way of example. Referring to FIG. 8, an to environment 400, including an illumination sensor 401 and a lighting device 402, is provided, and various IoT functions 410 may be provided in the IoT environment 400 by the illumination sensor 401 and the lighting device 402. For example, an illumination detection function 411, an illumination increase function 412, an illumination decrease function 413, and an illumination setting function 414 may be provided to the environment 400 by the illumination sensor 401 and the light device 402. For example, the illumination setting function 414 may be a function implemented by combining at least a portion of other functions 411 to 413. For example, the illumination setting function 414 may set an illumination condition (e.g., a preset intensity of illumination) by using the illumination detection function 411, illumination increase function 412 and illumination decrease function 413. The IoT environment 400 and the IoT function 410 may be stored in the IoT server. For example, the IoT function 410 may be a library of functions that may be stored in the IoT server.

The user terminal 420 may store and execute at least one IoT application 421. When a predetermined control command is transmitted in the IoT application 421, the IoT server may select a target function, corresponding to the transmitted control command, from the IoT function 410. For example, when the IoT application 421 transmits a control command to check current illumination of the IoT environment 400, the IoT server may select the illumination detection function 411 as a target function, from the IoT function 410.

When the target function is selected, the IoT server may select a target device, configured to execute the target function, from the IoT environment 400. In an exemplary embodiment of the present inventive concept illustrated in FIG. 8, the illumination sensor 401 may be selected as the target device. When the IoT devices 401 and 402 are installed in the IoT environment 400, the IoT server may match functions to be executed in the IoT devices 401 and 402 with a plurality of functions provided in the IoT function 410 and store the functions. When the illumination sensor 401 is selected as a target device, the IoT server may generate a command having an instruction for the illumination sensor 401 to detect an illumination value and to output the detected illumination value to the IoT server, and the IoT server may transmit the command to the generating illumination sensor 401. In this case, the IoT server may generate the instruction and the command in a format to be executed by the illumination sensor 40.

The IoT server may convert the illumination value, received from the illumination sensor 401, into a format to be recognized by the IoT application 421, again, and then may transmit the converted illumination value to the user terminal 420. In other words, in an exemplary embodiment of the present inventive concept, the IoT server may mediate communications among devices developed in different development environments and/or by different manufacturers. For example, the IoT server recognizes and stores the IoT devices 401 and 402, installed in the IoT environment 400, according to a function executable in each of the IoT devices 401 and 402, thereby significantly increasing scalability of an IoT system.

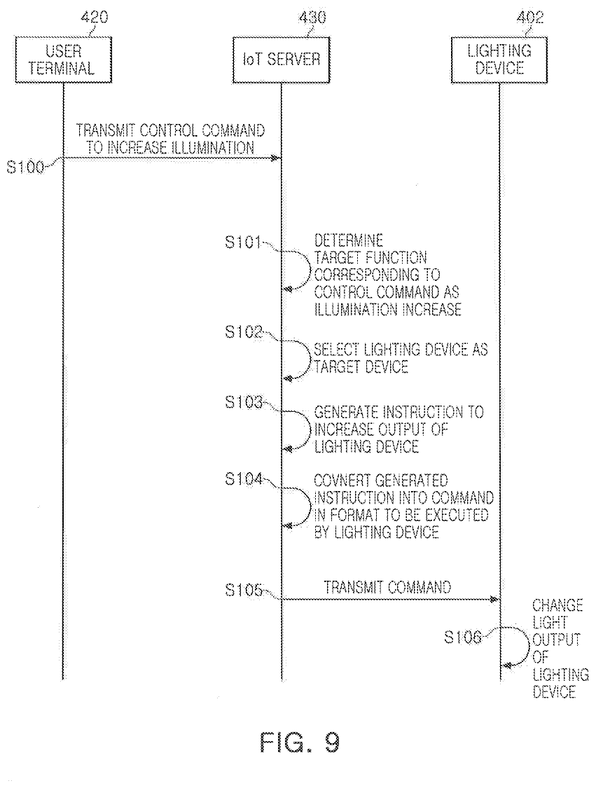

FIG. 9 is a schematic diagram according to an exemplary embodiment of the present inventive concept in which a lighting device 402 (e.g., an electronic device) is controlled by a user terminal 420 to increase illumination.

Referring to FIG. 9, a control command to increase illumination may be transmitted from the user terminal 420 to the IoT server 430 (S100). The control command, transmitted to the IoT server 430 in S100, may be generated by an IoT application executed in the user terminal 420.

The IoT server 430 may determine a target function corresponding to the received control command as increasing illumination (S101), and may select the lighting device 402 as the target device for executing the target function determined in S101 (S102). The IoT server may generate an instruction to increase light output of the lighting device 402 selected as a target device (S103), and may convert the corresponding instruction into a command in a format to be executed by the lighting device 402 (S104).

If the IoT server 430 transmits the control command, received from the user terminal 420, to the lighting device 402, the lighting device 402 may not recognize the control command due to, for example, a difference in operating systems of the lighting device 402 and the user terminal 420. Thus, the IoT server 430 may determine a target function corresponding to the control command, received from the user terminal 420, and then, may generate an instruction in a format suitable for a target device capable of executing the target function.

The IoT server 430 may transmit the generated command to the lighting device 402, the target device (S105). The lighting device 402 decodes the received command to increase light output according to an instruction included in the command, thereby increasing illumination of the IoT environment 400 (S106).

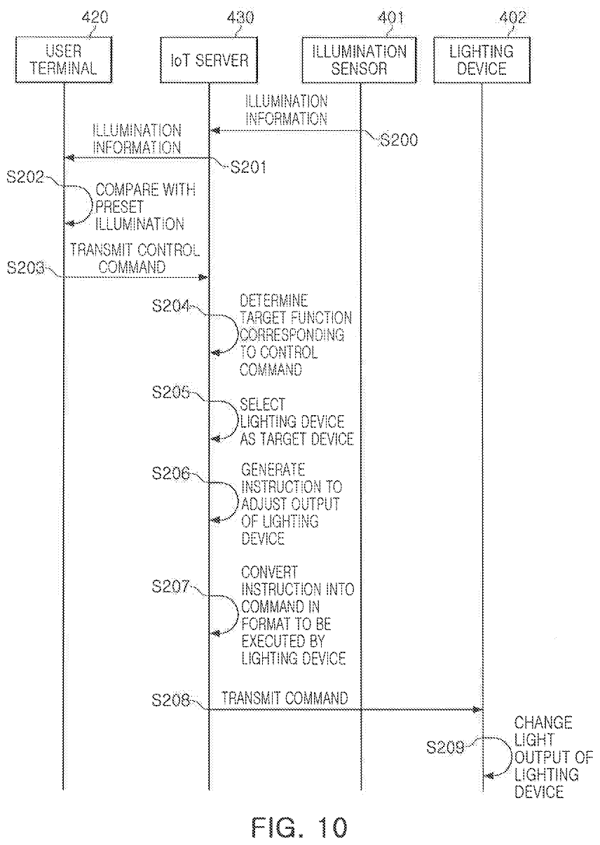

FIG. 10 is a schematic diagram according to an exemplary embodiment of the present inventive concept in which a lighting device 402 is controlled by a user terminal 420 to set illumination.

Referring to FIG. 10, illumination information, detected by the illumination sensor 401, is transmitted to the IoT server 430 (S200), and the IoT server 430 may transmit the illumination information to the user terminal 420, again (S201). During a process for transmitting illumination information, the IoT server 430 may process a difference in operating system and instruction formats between the illumination sensor 401 and the user terminal 420, a difference in various data formats between the illumination sensor 401 and the user terminal 420, and the to like. For example, the IoT server 430 may store information relating to operating systems of various IoT devices. In an additional example, the IoT server 430 may process a difference between a data format of a command from the user terminal 420 and a data format that is recognizable by the illumination sensor 401 such that the command coming from the user terminal 420 can be recognized and acted upon. In an exemplary embodiment of the present inventive concept, the IoT server 430 may convert the illumination information into a format that is to be decoded by the IoT application of the user terminal 420, and transmit the illumination information to the user terminal 420.

The user terminal 420, receiving the illumination information, may compare preset illumination with the illumination information (S202), and may transmit a control command to the IoT server 430 according to a comparison result (S203). For, example, the IoT application of the user terminal 420 may receive and store an appropriate illumination range over time as a default, or from a user. When the illumination information, received in S201, is out of a preset illumination range, the IoT application may generate a control command to change illumination and transmit the control command to the IoT server 430.

The IoT server 430 may determine a target function corresponding to the control command received from the user terminal 420 (S204), and may select a lighting device 402 as a target device for executing the target function (S205). For example, when the information, received in S201, is less than a lower value in a preset illumination range, the target function may be increasing illumination. In addition, when the illumination information, received in S201, is greater than an upper value in a preset illumination range, the target function may be decreasing illumination.

The IoT server 430 may generate an instruction to adjust output of the lighting device 402, based on the target function determined in S204 (S206), and may convert the instruction into a command to be recognized and/or executed by the lighting device 402 (S207). The IoT server 430 may transmit the command to the lighting device 402 (S208), and the lighting device 402 may change light output based on the command (S209). According to an exemplary embodiment of the present inventive concept, the command may include not only an instruction to simply increase or decrease light output of the lighting device 402, but may also include an illumination setting over time and/or an illumination setting according to whether a person is present in the IoT environment 400. For example, an illumination setting over time may include increasing the light output of the light device 402 as the time of day becomes later.

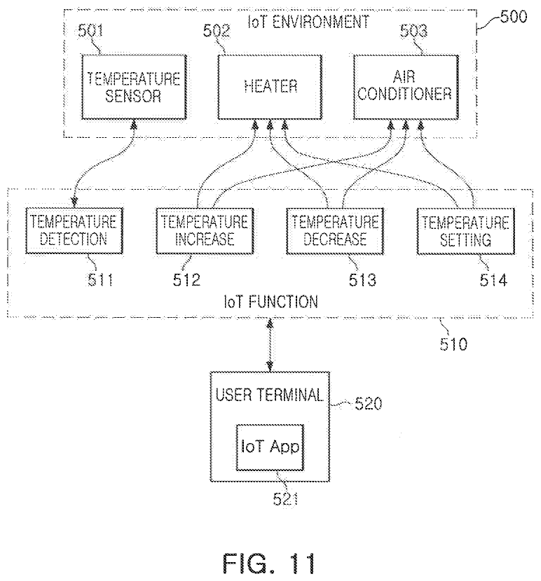

FIG. 11 is a schematic drawing illustrating an operation of an IoT server, such as a temperature control function, by way of example. Referring to FIG. 11, an IoT environment 500, including a temperature sensor 501, a boiler 502, an air conditioner 503, is provided, and various IoT functions 510 may be provided in the IoT environment 500 by the temperature sensor 501, the boiler 502, and the air conditioner 503. For example, a temperature detection function 511, a temperature increase function 512, a temperature decrease function 513, and a temperature setting function 514 may be provided to the IoT environment 500 by the temperature sensor 511, the boiler 502 and the air conditioner 503. The IoT environment 500 and the IoT function 510 may be stored in the IoT server.

The user terminal 520 may store and execute at least one IoT application 521. When a control command is transmitted in the IoT application 521, the IoT server may select a target function, corresponding to the control command, from the IoT function 510. For example, when the IoT application 521 transmits a control command to increase a temperature of the IoT environment 500, the IoT server may select a temperature increase function 512 as a target function from the IoT function 510.

When the target function is selected, the IoT server may select a target device, configured to execute the target function, from the IoT environment 500. In an exemplary embodiment of the present inventive concept illustrated in FIG. 11, when a target function is a temperature increase function 512, the boiler 502 and/or the air conditioner 503 may be selected as a target device. For example, the IoT server may select a device currently in operation, the boiler 502 and/or air conditioner 503, as a target device. For example, the IoT server may generate an instruction to increase a target temperature that is to be executed by the boiler 502 and/or the air conditioner 503, or to stop an operation of the air conditioner 503. The IoT server may convert the instruction into a command in a format to be executed by the boiler 502 and/or the air conditioner 503, and may transmit the command to the boiler 502 and/or the air conditioner 503.

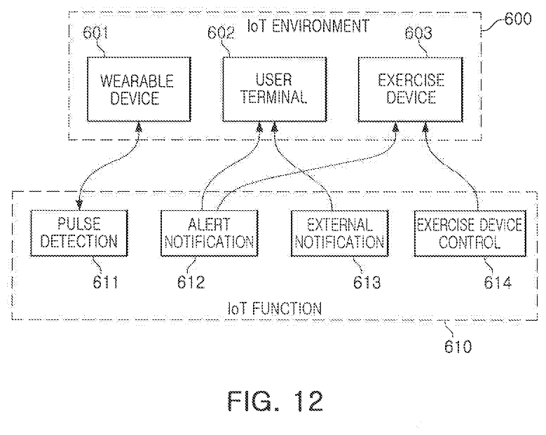

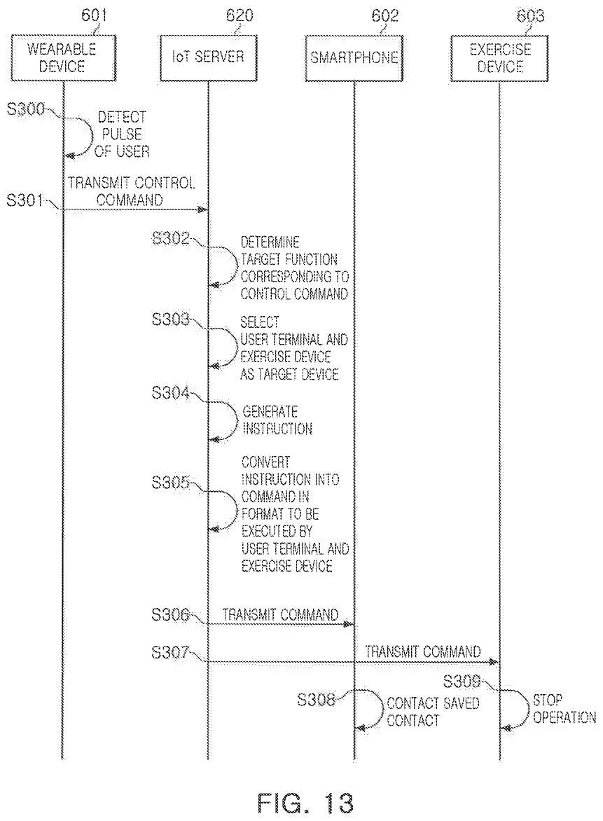

FIGS. 12 and 13 are schematic diagrams illustrating an operation of an IoT server, such as a physical condition monitoring function of a user, according to an exemplary embodiment of the present inventive concept. Referring to FIG. 12, an IoT environment 600 may include a wearable device 601, a smartphone (e.g., a user terminal) 602, an exercise device 603, and the like, as IoT devices. In addition, the IoT server, providing an IoT service in the IoT environment 600, may store a pulse detection function 611, an alert notification function 612, an external notification function 613, an exercise device control function 614, and the like, as IoT functions.

In an exemplary embodiment of the present inventive concept illustrated in FIG. 12, the wearable device 601 and the smartphone 602 may be operated as a user terminal. When a user wears the wearable device 601 during, for example, the day or an exercise routine, the IoT server may execute the pulse detection function 611 periodically or at predetermined time intervals. For example, the IoT server may execute the pulse detection function 611 for each set period or time by the wearable device 601 and/or the smartphone 602. The IoT server may execute at least one among the alert notification function 612, the external notification function 613, and/or the exercise device control function 614 based on a pulse of a user detected through the wearable device 601. The exemplary embodiment described above will be described later with reference to FIG. 13.

In an exemplary embodiment of the present inventive concept, in executing at least one among the pulse detection function 611, the alert notification function 612, the external notification function 613, and/or the exercise device control function 614, as a target function, the IoT server may generate and transmit an instruction in a format to be recognized and executed by the target device. For example, the instruction transmitted to the target device may include the target function that is to be performed by the target device. Thus, IoT devices or IoT modules operated according to different operating systems, firmware, or the like, may be compatible by using a format conversion function of the IoT server according to an exemplary embodiment of the present inventive concept. As a result, scalability and compatibility of the IoT system may be increased.

Next, referring to FIG. 13, the wearable device 601 may detect a pulse of a user (S300). For example, the wearable device 601 may include a smart watch, a virtual reality (VR) device, a patch type device attached to a user's body, and may obtain information on a body of a user including a pulse rate and/or heart rate, through an electrode in contact with a body of a user.

The wearable device 601 may transmit a control command including the pulse rate obtained in S300 to the IoT server 620 (S301). In S301, the wearable device 601 may transmit a pulse rate to the IoT server 602, or may transmit the control command to the IoT server 602 by including an instruction to control other IoT devices, in the IoT environment 600, based on the pulse rate.

The IoT server 620 may determine a target function corresponding to the control command (S302), and may select a target device capable of implementing the target function (S303). For example, when a pulse rate of a user is significantly fast, the IoT server 620 may select a function to stop an operation of the exercise device 603 and to contact a designated contact stored in the smartphone 602, as a target function corresponding to the control command.

The IoT server 620 may generate an instruction to control the target function, determined in S302, to be executed in the target device, determined in S303 (S304). To secure compatibility among various IoT devices present in the IoT environment 600, the IoT server 620 may convert the instruction into a command in a format to be executed in the target device (S305). The command, generated in S305, may be transmitted to the smartphone 602 and the exercise device 603, a target device (S306 and S307). For example, a first command may be transmitted to the smartphone 602 (S306), and then, a second command may be transmitted to the exercise device 603 (S307). Further, the first command may have a format different from that of the second command.

The smartphone 602 may contact a pre-designated contact in response to the command (S308). Thus, when a pulse rate of a user is significantly fast or slow, prompt first aid treatment may be desired. In addition, when the exercise device 603 is in operation, the exercise device 603 may stop an operation in response to the command (S309). Thus, excessive use of the exercise device 603 by a user may be prevented.

According to an exemplary embodiment of the present inventive concept, a format conversion function with respect to an instruction, transmitted and received between IoT devices, may be implemented in the IoT server. Thus, compatibility among IoT modules and IoT devices operated according to, for example, different firmwares, operating systems, or the like, may be secured, and scalability of the IoT system may be increased. The IoT server may store an IoT environment, in which an IoT system is implemented, and IoT functions provided in the IoT environment. When the IoT device is connected to the IoT environment, the IoT server may match and store pieces of function information to be executed by the IoT device with IoT functions.

When the control command is received from the IoT application by, for example, a user input, the IoT server selects a target function, corresponding to a control command, from pre-stored IoT functions, and selects one or more target devices, configured to execute a target function. The IoT server transmits a control command to the target device after converting a format of the control command based on the selected target device, and/or firmware of an IoT module mounted in the target device, an operating system, and the like. Thus, compatibility among the IoT devices produced/sold by different manufacturers is achieved, and a user may freely extend and transform an IoT environment by connecting various IoT devices to the IoT system.

As set forth above, according to an exemplary embodiment of the present inventive concept, an IoT server may recognize IoT functions provided by IoT devices connected to an IoT network, and IoT devices based on an IoT environment in which IoT devices are installed may perform the IoT functions. In addition, the IoT server may, for example, receive communications from IoT devices and user terminals, process the received communications so that they are compatible with their destined IoT devices, and transmit the communications to the destined IoT devices. The IoT server may classify and store information of IoT devices according to IoT functions, and may generate a command in a format compatible with the IoT devices so that IoT devices may execute an IoT function. Thus, compatibility among various IoT devices produced and/or sold by various manufacturers may be secured, and convenience of a user may be achieved.

Herein, exemplary embodiments of the present inventive concept are described, and illustrated in the drawings, in terms of functional blocks, units and/or modules. Those skilled in the art will appreciate that these blocks, units and/or modules (e.g., an environment setting unit, a function setting unit, a format converting unit, a sensor unit, a communications unit) are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies, in the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the scope of the inventive concepts. Further, the blocks, units and/or modules of the embodiments may be physically combined into more complex blocks, units and/or modules without departing from the scope of the inventive concepts.

While the present inventive concept has been particularly shown and described with reference to exemplary embodiments thereof, it will be apparent to those of ordinary skill in the art that various changes in form and detail may be made thereto without departing from the spirit and scope of the present inventive concept as defined by the following claims.

What is claimed is:

1. An Internet-of-Things (IoT) server, comprising:
a storage configured to store function information of a plurality of IoT devices, wherein the stored function information of the plurality of IoT devices are classified based on IoT functions to be implemented in an IoT environment; and
a controller configured to generate a second command to control a target device among the plurality of IoT devices to execute at least one IoT function of the IoT functions, in response to a first command from an IoT application, wherein the first command is converted into a format executable in the target device and transmitted to the target device as the second command.

2. The IoT server of claim 1, wherein the IoT environment is stored in the storage.

3. The IoT server of claim 2, wherein the IoT functions include a detection function for detecting an environmental condition of the IoT environment, a control function for changing the environmental condition in the IoT environment, and a setting function for setting the environmental condition using the detection function and the control function.

4. The IoT server of claim 1, wherein the plurality of IoT devices include first IoT devices implementing a first function among the IoT functions, and
the controller implements the first function by transmitting commands in different formats, to at least one of the first IoT devices.

5. The IoT server of claim 1, wherein the plurality of IoT devices include a plurality of sensors detecting an environmental condition of the IoT environment, and a plurality of electronic devices changing the environmental condition in the IoT environment.

6. The IoT server of claim 1, wherein the storage stores identification information of the plurality of IoT devices.

7. The IoT server of claim 1, wherein the IoT functions are stored in the storage.

8. The IoT server of claim 1, wherein the IoT environment includes the plurality of IoT devices.

9. The IoT server of claim 1, wherein the first command and the second command include data according to different data formats.

10. An Internet-of-Things (IoT) server, comprising:
a network generation unit configured to provide an IoT network, wherein the IoT network includes a plurality of IoT devices that receive commands in different formats to implement IoT functions and a user terminal executing an IoT application for controlling the plurality of IoT devices; and
a processor configured to store function information of the plurality of IoT devices and classify the function information according to the IoT functions, to generate a command in a format to be executed by each of the plurality of IoT devices, and to transmit the command to the plurality of IoT devices in response to a control command from the IoT application.

11. The IoT server of claim 10, wherein the IoT network provides an IoT environment that include the plurality of IoT devices.

12. The IoT server of claim 10, wherein first and second IoT devices operate according to different operating systems.

13. The IoT server of claim 10, wherein the user terminal generates the control command based on a first format for the IoT application and transmits the control command to the IoT server, and
the processor converts the control command into the command having a second format, different from the first format, and transmits the command to at least one of the plurality of IoT devices.

14. The IoT server of claim 10, wherein the control command and the command have different data formats from each other.

15. The IoT server of claim 10, wherein the processor converts information, collected from the plurality of IoT devices, into a format to be decoded by the IoT application, and transmits the converted information to the user terminal.

16. An Internet-of-Things (IoT) server, comprising:
a storage configured to store function information corresponding to IoT functions provided by a plurality of IoT devices in a space; and
a controller configured to select a target function among the IoT functions and a target device among the plurality of IoT devices in response to a first command from an IoT application, to generate a second command for providing the target function in a format executable in the target device, and to transmit the second command to the target device.

17. The IoT server of claim 16, wherein the controller selects at least two target devices based on the target function.

18. The IoT server of claim 17, wherein at least two second commands are generated, and the at least two second commands are respectively transmitted to the at least two target devices, wherein the at least two second commands have different formats.

19. The IoT server of claim 16, wherein the controller transmits the first command to the target device when formats of the first command and the second command are the same.

20. The IoT server of claim 16, wherein the function information includes environment detection information obtained by detecting an environmental condition of the space, environment control information changing the environmental condition of the space, and environment setting information setting the environmental condition of the space.
